(19) United States
(12) Patent Application Publication
(10) Pub. No.: US 2012/0173837 A1
(43) Pub. Date: Jul. 5, 2012

(54) MEMORY SYSTEM

(76) Inventors: Klaus Schneider, Ludwigsburg (DE); Rainer Puchalla, Pluederhausen (DE); Daniel Hensel, Niederfischbach (DE)

(21) Appl. No.: 13/395,288

(22) PCT Filed: Oct. 13, 2010
(86) PCT No.: PCT/EP10/65331

§ 371 Date: Mar. 9, 2012

(30) Foreign Application Priority Data
Nov. 9, 2009 (DE) 10 2009 046 518.9

(51) Int. Cl. G06F 12/06

(52) U.S. Cl. 711/170; 711/E12.084

(57) ABSTRACT

A memory system is described having a memory, at least one memory area of the memory being able to be configured as data memory or as buffer store as a function of a required memory processing rate.

### FIELD OF THE INVENTION

The present invention relates to the field of memory architectures in data processing systems.

### BACKGROUND INFORMATION

Modern data processing systems frequently use buffer stores, so-called cache memories, for temporary storage in order to achieve higher data processing rates. This is advantageous in particular in data processing systems such as control units of vehicles or in personal computers (PCs) where, for example, data and commands from a main memory are to be made available to a command interpreter at very short access times. Depending on the type of data stored in the main memory, the main memory may be implemented as RAM memory for data storage (RAM: Random Access Memory) or as ROM memory for storing program commands (ROM: Read Only Memory). Due to the necessarily required high storage capacity, however, short access times can be realized only by an enormous technical investment, which is not economical and technically difficult. The data flow rates may therefore differ as a function of the development of the main memory. For this reason, the aforementioned buffer stores which have a smaller storage capacity and consequently shorter access times are connected, for instance between functional units communicating with each other, such as between a main memory and a command interpreter.

An operation of the buffer store is usually organized in such a way that the data and commands requested by a command interpreter while the program is running are in all likelihood already located in the buffer store at the time they are required, which makes it possible to reduce the access times due to the lower number of pauses in the processing of a computer program and an attendant increase in the processing rate.

If a main memory is to be used both for data storage and for command storage, which is a requirement in diagnosis systems which are used in engine control systems for diagnosing drives, for instance, then it is often necessary, however, to reserve an area in the main memory for data storage, which increases the required capacity even further. In addition, the data memory may be used as program memory, for which purpose a program command sequence is copied from a permanent program memory to a non-permanent data memory. In U.S. Pat. No. 7,096,385 B1, for example, a cache memory is used for the temporary storage of diagnostic program instructions in a system for checking a microprocessor. However, this approach is not resource-efficient because it requires the provision of a cache memory intended exclusively for the buffer storage of commands.

### SUMMARY

In accordance with the present invention, an efficient memory system is able to be realized by the dynamic configuration of a memory as a data memory for data storage or as a buffer store, i.e., cache memory, for the temporary storage of program commands.

According to one aspect, the present invention relates to a memory system having a memory, in which at least one memory system of the memory is able to be configured as data memory or as buffer store as a function of a required memory processing rate. If the at least one memory area of the memory is configured as data memory, then it may be utilized for permanent data storage, for instance. On the other hand, if the at least one memory area is configured as temporary buffer store, then it is used for storing program commands, for example.

According to one advantageous specific development, another memory area of the memory area is able to be configured as data memory or as temporary buffer store. However, both memory areas of the memory may be configured as data memory or also as permanent buffer store, so that the entire memory is able to be configured as data memory or as temporary buffer store.

According to one advantageous specific embodiment, a control unit or processor is provided for configuring the memory, so that the memory is advantageously able to be configured by a superposed entity.

According to one advantageous specific embodiment, the memory system includes an additional memory, which is connected upstream from the aforementioned memory, a memory processing rate of the memory being not higher, preferably lower, than a memory processing rate of the additional memory. For example, this may be achieved in that the memory capacity of the memory is lower than the memory capacity of the additional memory, so that an advantageous increase in the processing rate is achievable.

According to one specific embodiment, the memory system includes another memory, e.g., the aforementioned memory, which is connected upstream from the memory, the additional memory being reachable via the memory, for instance exclusively via the memory, which advantageously makes it possible to increase the memory processing rate, in particular if the memory is configured as cache memory.

According to one specific embodiment, the memory system includes an additional memory which is linked to the memory, such as connected upstream therefrom, the additional memory having a data storage area for data storage, and/or a program memory area for storing program commands, the at least one memory area of the memory being configurable as temporary buffer store assigned to the data memory area and/or to the program memory area, and/or another memory area of the memory being configurable as data memory assigned to the data memory area and/or to the program memory area. Thus, the memory may have, for example, a data memory area for longer-term data storage, and a temporary buffer store area for cache storage, which makes it possible to achieve advantageous flexibility of the memory system.

According to one advantageous specific embodiment, the required memory processing rate includes an access speed which is required to process certain data, for instance, or a storage speed. The required memory processing rate may furthermore depend on a required data processing rate or a required command reading rate, so that the memory system according to the present invention may be used in a multitude of different data processing scenarios.

According to one advantageous specific embodiment, the required memory processing rate is definable on the basis of a required data processing speed or a required command reading speed, so that the memory is advantageously able to be configured according to need.

According to one advantageous specific embodiment, the at least one memory area of the memory is configurable when initializing the memory system. For example, the memory system may be initialized by a processor accessing it, or it may be co-initialized when initializing the processor, which advantageously ensures that the memory configuration is able to be implemented in application-specific manner, such as for diagnosis purposes, for instance.

According to another aspect, the present invention relates to a data processing device such as an engine control device, which may be programmable, having the memory system according to the present invention and a processor device, e.g., a processor designed to access the memory system.

According to another aspect, the present invention relates to a drive control device for controlling a vehicle drive, which includes the memory system according to the present invention to store drive diagnosis data or program commands for carrying out a diagnosis of the vehicle drive.

According to another aspect, the present invention relates to a memory configuration method for configuring an operating mode of a memory, which includes the step of configuring at least one memory area of the memory as data memory or as temporary buffer store as a function of a required memory processing rate.

Additional method steps derive directly from the functionality of the memory device according to the present invention.

### BRIEF DESCRIPTION OF THE DRAWINGS

Additional exemplary embodiments are explained with reference to the figures.

FIG. 1 shows a data processing device.

FIG. 2 shows a data processing device.

### DETAILED DESCRIPTION OF EXAMPLE EMBODIMENTS

FIG. 2 shows a data processing device having a memory system which includes a memory 101 and another memory 103 connected upstream therefrom. In addition, the data processing system includes a command interpreter 105 which is connected downstream from memory 101.

Memory 101 is preferably able to be configured and may be used as temporary buffer store or as primary data memory, for example. Additional memory 103 includes, for example, a data memory area 107 and a program memory area 109, both memory areas communicating with memory 101. Data memory area 107 may be realized by a RAM (RAM: Random Access Memory), for example. On the other hand, program memory area 109 is realizable by means of a ROM (ROM: Read Only Memory), for instance.

For the purpose of configuring memory 101, it may be configured entirely as buffer store or as data memory, for example. Furthermore, it is possible to configure one or more memory area(s) of memory 101 as buffer store and/or as data memory.

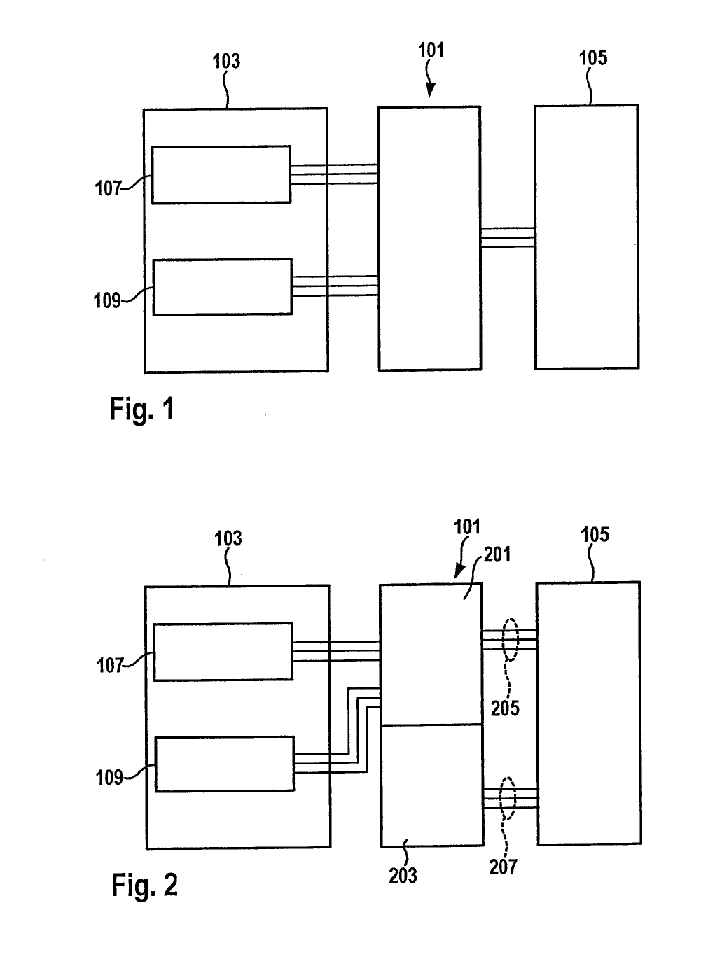

FIG. 2 shows the data processing device from FIG. 1 according to another exemplary embodiment, in which memory 101 has a memory area 201, which is configured as buffer store area, for instance, and includes an additional memory area 203, which, for example, is configured as data and/or program memory. As shown in FIG. 2, data memory area 107 and program memory area 109 communicate with buffer store area 201 of memory 101. Additional memory area 203, on the other hand, is used as primary data memory which is able to be separately accessed by command interpreter 105, for instance. According to one specific embodiment, these accesses may be implemented in bus-oriented manner. According to another specific embodiment, it is possible to provide separate lines 205 and 207 for this purpose, command interpreter 105 communicating with buffer store area 201 via lines 205, and with data and/or program memory area 203 via lines 207. Lines 205 and 207 may be provided on a temporary basis or be hardwired.

The aforementioned RAMs are usable as data memory or as main memory of the data processing device. It is also possible to utilize them as write/read memory. Since the access time for all memory cells is of approximately equal length both during read and write operations, the RAMs are therefore denoted as memory with random access in this case. As a rule, the RAMs may be used as non-permanent memory, i.e., the data are preferably stored only until the current supply is interrupted. Such a buffer store, however, may also be used as program memory, for which a command sequence is able to be copied from a permanent program memory into the non-permanent data memory.

Due to the placement of memory 101 according to the present invention as illustrated in FIGS. 1 and 2, said memory being utilizable as buffer store or as cache, it is possible to use it as data and/or program memory, either completely or partially, so that a flexible memory capacity is able to be made available. If memory 101 is temporarily not used as cache but as data memory, then it is temporarily not used as buffer store.

Memory 101 is able to be used primarily as buffer store, which could be its primary function, and additionally as data and/or program store, which could be its secondary function. The switchover between primary and secondary function is able to take place as needed and dynamically, for example.

Since the cache of the data processing device utilized as buffer store may be used as data and/or program memory, it is possible to adapt the processing rate of the memory system to the required data processing rate. If memory 101 is configured as data and/or program memory, for instance, then the maximally possible processing rate, i.e., memory processing rate, is lower in comparison to the temporary cache operating mode. However, if the reduced processing rate suffices for the individual application, then memory 101 may advantageously be configured as program and/or data memory.

Based on the data, the data processing device is able to determine when it is possible to configure memory 101 into the individual operating mode. If memory 101 is to be used as program and/or data memory, this may be specified when initializing it, for instance. In the process, memory 101, which otherwise is used as cache memory, can be reconfigured from the primary function to the secondary function. However, if memory 101 is to be used as buffer store, then a reconfiguration to the primary function may take place. This dynamic switchover of the operating modes provides the option of utilizing memory 101 as a function of need, so that, depending on the requirements, an optimization with regard to run time or with regard to the available resources in view of the program and/or data memory may take place.

Preferably, the memory system or the data processing device according to the present invention may be used in an engine control unit which has the capability of implementing a diagnosis of a drive.

To diagnose a fault of the drive, a diagnosis function is advantageously started in the engine control unit, for whose processing, however, no maximum processing speed is required. Toward this end, a signal may be recorded over time, for example, the recorded data then being analyzable with the aid of an algorithm. These signal data may be stored, for instance in the dynamically configurable memory 101 which is able to be configured as data memory, and made available to the algorithm for analysis.

Conventional diagnosis functions may be subdivided into two groups, for instance. Included in the first group are, for example, functions that are executed while driving. On the other hand, special diagnosis functions that are able to be activated exclusively during a stay at a service facility, for example, may be part of the second group. The main memory is usually utilized as program store in such a case, although this functionality is required only very rarely and never during actual driving operation. Due to this temporary provision of the data memory area that is possible according to the present invention, the system resources may be utilized in more optimal manner.

Via a software upload in a service facility, the diagnosis function may furthermore be loaded into an upload memory area, which is able to be made available in memory 101 dynamically rather than statically.

For the reconfiguration of the cache into the primary or into the secondary function, it is possible, for instance, to use a hardware-based control in a control unit, which configures memory 101 as a function of a particular application, such as a diagnosis function. However, the reconfiguration of the cache need not necessarily take place via a hardware-based control. It may also be implemented in software technology, in the form of a software program, which carries out the reconfiguration of the cache during the control unit initialization, triggered by a diagnosis tester.

1-12. (canceled)

13. A memory system, comprising:
a memory, at least one memory area of the memory is able to be configured as data memory or as buffer store as a function of a required memory processing rate.

14. The memory system as recited in claim 13, wherein an additional memory area of the memory is able to be configured as data memory or as temporary buffer store.

15. The memory system as recited in claim 13, further comprising:
a control unit for configuring the memory as a function of the required memory processing rate.

16. The memory system as recited in claim 13, further comprising:
a further memory, at least one memory area of the memory is assignable to an additional memory as buffer store.

17. The memory system as recited in claim 13, further comprising:
a further memory which is linked to the memory, a memory processing rate of the memory being lower than a memory processing rate of the further memory.

18. The memory system as recited in claim 13, further comprising:
an additional memory linked to the memory, the additional memory having at least one of a data memory area for data storage, and a program memory area for program command storage, and the at least one memory area of the memory being configurable as temporary buffer store assigned to the at least one of data memory area and the program memory area.

19. The memory system as recited in claim 13, further comprising:
an additional memory linked to the memory, the additional memory having at least one of a data memory area for data storage and a program memory area for command program storage, an additional memory area of the memory being configurable as data memory assigned to the at least one of the data memory area and the program memory.

20. The memory system as recited in claim 13, wherein the required memory processing rate one of: i) includes an access time, ii) includes a storage speed, iii) is a function of a required data processing rate, or iv) is a function of a required command reading speed.

21. The memory system as recited in claim 13, wherein the required memory processing rate is defined based on one of a required data processing rate or a required command reading speed.

22. The memory system as recited in claim 13, wherein the at least one memory area of the memory is able to be configured when initializing the memory system.

23. A data processing device, comprising:
a memory system including a memory, at least one memory area of the memory being able to be configured as data memory or as buffer store as a function of a required memory processing rate; and
a processor device which is configured to access the memory system.

24. A drive control unit for controlling a vehicle drive, the drive control unit including a data processing device comprising a memory system including a memory, at least one memory area of the memory being able to be configured as data memory or as buffer store as a function of a required memory processing rate, and a processor device which is configured to access the memory system, the data processing device to store at least one of drive diagnosis data or program commands for implementing a diagnosis of the vehicle drive.

25. A method for configuring memory, comprising:
configuring at least one memory area of the memory as data memory or as buffer store as a function of a required memory processing rate.
